(19) United States
(12) Patent Application Publication
(10) Pub. No.: US 2025/0177812 A1
(43) Pub. Date: Jun. 5, 2025

(54) PORTABLE REHABILITATION DEVICE WITH VISUAL BIOFEEDBACK AND PELVIC STABILIZATION

(71) Applicant: MOVAO, LLC, Montgomery, TX (US)

(72) Inventor: Darin Wayne Trees, Montgomery, TX (US)

(21) Appl. No.: 18/966,723

(22) Filed: Dec. 3, 2024

Related U.S. Application Data
(60) Provisional application No. 63/605,539, filed on Dec. 3, 2023.

(51) Int. Cl. A63B 22/20; A63B 21/04; A63B 21/055; A63B 22/00; A63B 71/06

(52) U.S. Cl. CPC A63B 22/203; A63B 21/0428; A63B 21/0557; A63B 22/0087; A63B 71/0622; A63B 2022/0094; A63B 2208/0233; A63B 2220/20; A63B 2220/833; A63B 2225/09; A63B 2225/50

(57) ABSTRACT

A portable therapeutic exercise device is disclosed for strengthening leg muscles in patients with severe muscular weakness after bedrest. The device features a lightweight, compact base with longitudinal rails and a moving carriage equipped with an adjustable footplate, cushion, and straps for secure engagement. Resistance cords provide variable tension, and a lumbar bolster with an adjustable strap stabilizes the base. A distance sensor and Bluetooth-enabled microcontroller relay real-time data to mobile devices for interactive visual biofeedback, including gaming applications. The carriage offers smooth linear motion via bearing wheels with adjustable spacers. Designed for use in hospital beds, chairs, or on the floor, the device provides a safe, adaptable, and engaging solution for rehabilitation exercises.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates to a therapeutic exercise device and more particularly a convenient exercise device that is adapted for restoring and/or maintaining muscle strength for patients who suffer from severe muscular weakness after prolonged bedrest.

### 2. Description of Related Art

This background information is intended to further educate the reader as to additional aspects of the prior art and may present examples of specific aspects of the prior art that is not to be construed as limiting the disclosure of the present application.

Recent medical advances have allowed more patients to survive serious injuries or disease processes than ever before. Unfortunately, the period of bed rest required for recovery may lead to severe deterioration of muscle strength and the inability to support full body weight upon standing. It is challenging for rehabilitation specialists to help these patients regain the ability to stand and begin ambulation. The current practice for physical therapists to help patients regain strength is using gravity to perform in-bed exercises such as heel slides, leg raises, or raising the lower leg with a pillow underneath the knee. Unfortunately, these exercises do not simulate the muscle forces required to stand with full body weight nor do they simulate the multi-joint kinematics and muscle recruitment patterns of sit to stand. Another option for in-bed leg exercise is for the therapist to provide manual resistance to a patient's leg during a simulated leg press exercise but this is limited by the strength of the therapist and can be tiresome for therapists for many repetitions.

Recently, therapists have started using a sports medicine device known as the Shuttle Minipress to provide resistance exercise in a patient's bed and described in U.S. Pat. No. 6,042,523. This exercise device involves a sliding carriage on a base that is placed underneath a patient's leg that allows a patient to perform a leg press exercise using resistance bands. Unfortunately, the device described in U.S. Pat. No. 6,042,523 has several limitations in the clinical application of hospitalized patients, especially those with critical illness or injuries. Disadvantages with this device is that is too heavy (15 pounds) and too large to fit in the hospital bed (3 ft. length). The length of the device makes it difficult to fit between a patient's leg and hospital bed footboard because the sled must travel the entire length of the rails during exercise. For tall patients, the bed footboard must be removed entirely to perform exercise with the device and it is unstable without a securing part against a surface. The device design also has several sharp edges that could harm a patient with fragile skin. Yet another problem is that the device lacks interaction with a patient during exercise sessions. It has no visual display or ability to play games to make exercise sessions enjoyable for users and enhance activity tolerance with longer therapy sessions. Finally, the device is flat on a bed surface and when pressure is applied to the footboard the device lifts upwards towards the end of the stroke. This is unsafe for patients as the device is not stable in a flat position in the bed.

There is a need for a portable exercise device that is designed specifically for physical therapy and strengthening of patients legs while lying in a bed. It would be desirable if the portable exercise device was lightweight, had no sharp edges, and the length was short enough so that it could fit in any bed. It would be desirable for the device to provide visual/auditory biofeedback of movement on the sliding sled making the activity enjoyable with games that are played on a smartphone or electronic pad via Bluetooth technology. It would also be desirable for the base of the device be secured by fixating to the patient's waist to prevent the light device base from sliding away off the bed during the leg press exercise. Such advancement in the portable exercise device would allow therapists or caregivers to provide safe and effective leg strengthening for patients while lying supine in a bed in preparation of full body weight standing again.

### Advantages of the Invention

Among the advantages of the invention is that it is lightweight (9 pounds) and compact (24 inches) to fit into any bed for patients with severe muscle weakness. Another advantage, the invention has distance sensor technology integrated into the device that allows users to play games on a smart phone or tablet App while exercising as the moving sled acts as the game controller. Another advantage, the rolling carriage has eccentric spacer nuts for the top wheel axles to allow fine tuning of the carriage's linear movement in the aluminum rails. Finally, another advantage is that the device base is secured to the patient's body via a lumbar bolster and adjustable strap to prevent the base from sliding away during exercise with an adjustable amount of resistance applied to the carriage.

Additional advantages of this invention will become apparent from an examination of the drawings and the ensuing description.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The present invention is designed to be used by patients in a hospital bed, but can be used on the floor, sitting in a chai, on a treatment table, or a desk.

The apparatus of the present invention comprises a support base having a front end, a rear end, and a longitudinal axis. The support base comprises two longitudinally extending rail means. There is a moving carriage mounted to the support base and engaging the rail means for back and forth travel along the longitudinal axis. The moving carriage also comprises a footplate to be engaged by a person to exert a rearwardly directed linear force on the footplate. The moving carriage has a front end and a rear end. It comprises a rail engaging support means for back and forth travel. The back of the base comprises a removable housing that holds a distance sensor, battery, changing means, on/off button, and with a microcontroller unit that has Bluetooth capability. The removable housing can be removed for easy charging of the battery through a port. During exercise, the distance sensor records the distance of the moving carriage in the rail and send the data to a mobile device via a microcontroller unit (MCU). It is also noted that load cells can be placed in the footplate or carriage that also can be used for gaming or visual feedback with a MCU showing how much of a load the user is pushing.

An ankle support cushion is also located on the moving carriage in front of the footplate to support the patient's ankle and heel during exercise. The pad is soft to prevent skin tears and there are no sharp edges on the device.

In the preferred form, the footplate comprises a contact plate which is adjustably mounted to the moving sled so as to be able to be positioned at various angular positions. The plate is pivotally mounted at the forward location of the moving sled, and the plate can be moved angularly in an upward or downward direction from the pivot location. A plate positioning means holds a plate at selected angular locations. The front top of the footplate which faces the user has a LED light bar and touchscreen display in the version with load cells and no LED display without load cells displaying the weight pushing through the plate. The footplate also has a softer non-slip cushioning pad that goes against the foot and a strap to hold the feet to the footplate. There are various modes of the force plate system with load cells which is shown on the display. Peak mode, isometric mode, and free mode will be explained later in the description.

The apparatus further comprises a stabilizing lumbar bolster attached to the support frame via an adjustable belt, and a second end having connecting means adapted to be connected to the patient's pelvis so as to position the apparatus at a stationary operating location. The stabilizing pelvic bolster means comprises a belt with a cam lock or velcro connected at forward locations on the support frame. In the preferred form, the stabilizing pelvic strap has a length and adjustment means incorporated therein so that the strap stays at a fixed length during exercise.

In the preferred form, the moving carriage has ten bearing wheels in total for smooth linear motion on the rails. Six vertical wheels (3 on each side) control the vertical motion and four horizontal wheels (One on each corner) control the lateral motion ensuring that the carriage moves linearly with any amount of resistance applied to it for resistance training. Eccentric spacers are used for the top-rail wheels that allow for precise axle placement in the extrusion aluminum rails. The wheel can be moved up or down by turning the eccentric nut with a hex wrench. The cord attaching means of the tensioning system comprises an attaching structure having attaching slots for the cord ends, each attaching slot being sized to permit its related cord to pass therethrough. Each slot has first and second enlarged openings, and the anchor end of each cord has an enlarged end portion which is sized to engage the edge portions of the attaching structure surrounding the opening to attach the anchor end of the cord to the attaching structure. The attaching structure is mounted to the forward end of the carriage housing to extend downwardly therefrom to hold the tension cords on the carriage when not engaged on the base.

In the method of the present invention, the apparatus is provided as above. The device is placed next to a patient's extended leg in bed and the lumbar bolster is placed under the patient's back. The weight of the pelvis keeps the lumbar bolster from moving. The pelvic strap is adjusted so that the front cap of the device's base is at the knee level. The moving carriage is then locked in place on the support base so that the patient's heel is placed on the ankle pad. Once the unit is moved under the leg, the sled is unlocked and moved towards the patient to flex the knee to approximately 45-degrees for muscle strength testing. The moving carriage is unlocked by the therapist and the sled is allowed to move. One or more of the tensioning cords are placed in the operating position as the patient's knee is flexed and the carriage is moved rearward against the force of the tension cord(s) and permitted to return for resistance training of the anti-gravity leg muscles.

The device also comprises a distance sensor that, in the preferred method, is located on the back of one of the rails and is removable for charging purposes of the battery. The distance sensor can used either light or sound waves that bounce from the carriage in line with the sensor, giving continual data to the MCU on carriage position on the frame. This data is sent out from the MCU via Bluetooth means to a smart phone or tablet to an App that allows users to play games during exercise, controlled by the carriage movement.

Other features of the present invention will become apparent from the following detailed description.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric view showing the present invention using the device to exercise the left leg in a lying position;

FIG. 2 is a side view of exercise with the device;

FIG. 3 is a back isometric view of the device;

FIG. 4 is a front isometric view of the device;

FIG. 5 is a back view of the device;

FIG. 6 is a front isometric view of the front cap;

FIG. 7 is a top view of the front cap;

FIG. 8 is a front view of the front cap;

FIG. 9 is a back view of the front cap;

FIG. 10 is an isometric view of the aluminum rail extrusion;

FIG. 11 is a front isometric view of the back cap;

FIG. 12 is a side view of the back cap;

FIG. 13 is a back isometric view of the back cap with removable game device;

FIG. 14 is a side and cross-sectional view of the cord holder;

FIG. 15 is a top view of the carriage top;

FIG. 16 is a side view of the carriage top;

FIG. 17 is a bottom isometric view of the carriage top;

FIG. 18 is a front view of the carriage top;

FIG. 19 is a front isometric view of the carriage bottom;

FIG. 19.5 is an isometric view of the carriage bottom and eccentric spacer;

FIG. 20 is an isometric front view of the carriage bottom with wheels;

FIG. 20.5 is a side view of carriage bottom with wheels;

FIG. 21 is a top view of carriage bottom with wheels;

FIG. 22 is an isometric side view of carriage bottom with wheels;

FIG. 23 is a back view of the carriage assembly;

FIG. 24 is a bottom view of the carriage assembly;

FIG. 25 is an isometric view of the carriage assembly;

FIG. 26 is a front view of the carriage assembly;

FIG. 27 is an isometric view of the carriage assembly;

FIG. 28 is a side view of the carriage assembly;

FIG. 29 is a top view of the carriage assembly;

FIG. 30 is the removable game device;

FIG. 31 is a schematic of the game device;

FIG. 32 is a top view of the device base with centered distance sensor on back cap;

FIG. 33 is an isometric view of the device base with distance sensor; and

FIG. 34 is a side view of the device base.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

While the system and method of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

### DETAILED DESCRIPTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

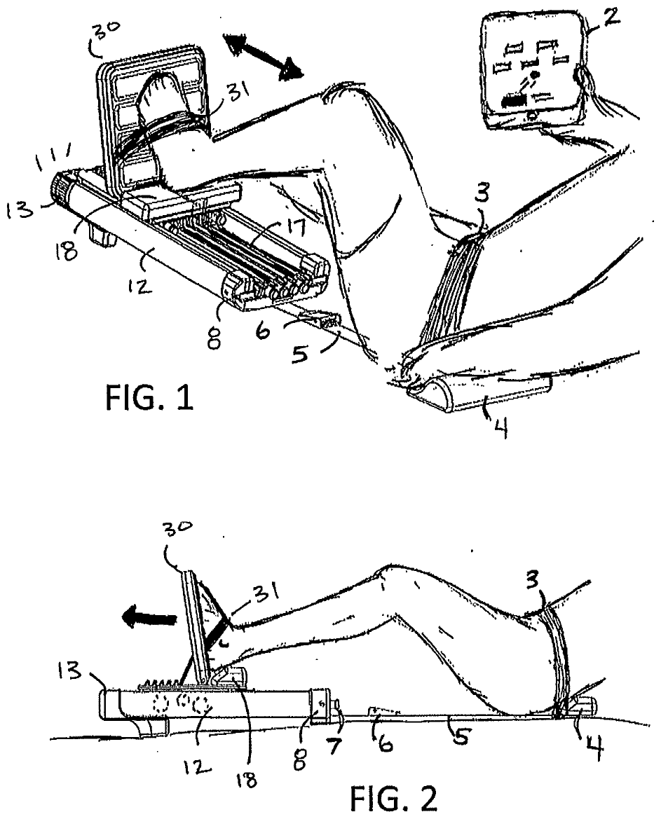

The present invention in FIGS. 1 and 2 shows the apparatus 10 being used by a patient to perform a left leg press exercise on a moving carriage against resistance cords 17. The lumbar bolster 4 is placed under the user's lumbar region with a waist strap 3 to secure the base of the device 10. An adjustable lumbar strap 5 is attached to the lumbar bolster 4 and can extend with the lumbar strap lock 6 according to a user's height. The lumbar strap 5 extends from the lumbar bolster 4 to the front cap 8 of the device 1. FIG. 1 shows a user performing the leg press exercise while the moving carriage controls the game on the mobile App tablet or phone 2.

FIG. 2 shows the user performing a leg press exercise by placing the heels on the ankle support pad 18 and the sole of the foot against the footplate cushion 27 and footplate 30 with a footstrap 31 that secures the foot to the footplate 30. The moving carriage assembly 29 glides up and down the aluminum extruded rails 12 in a linear fashion for progressive resistance exercise.

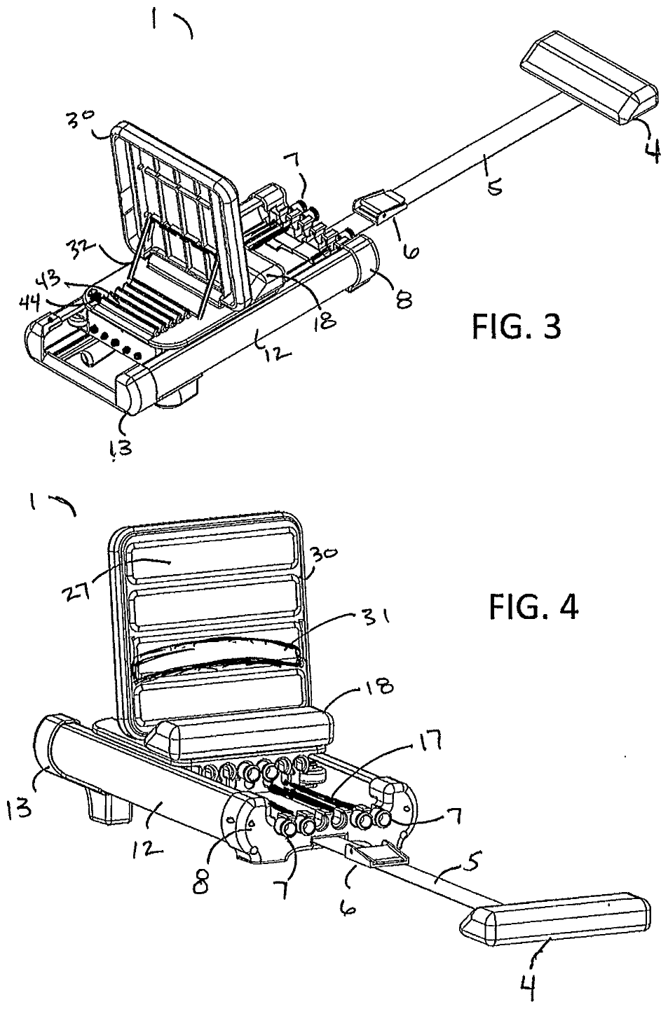

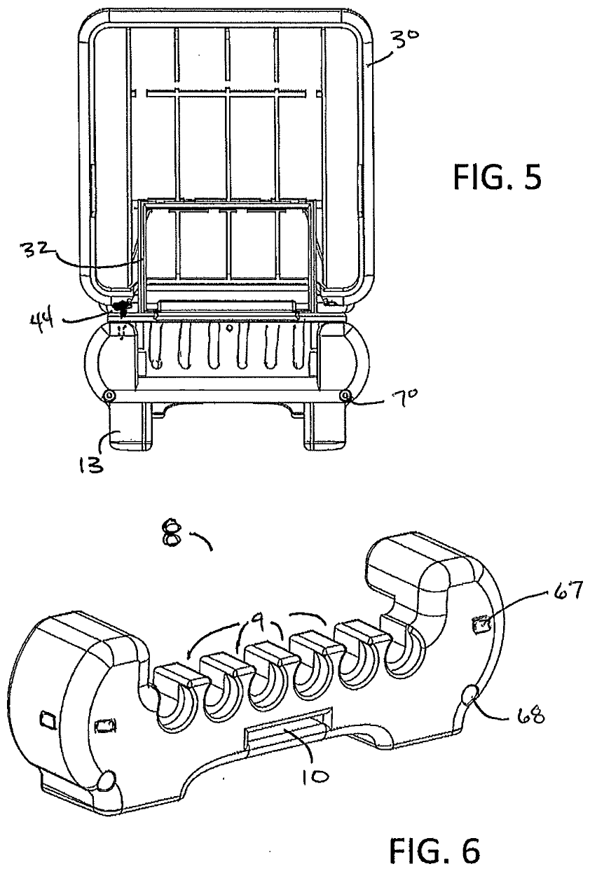

FIGS. 3 and 4 show the device 1 and how the footplate 30 angle is adjustable via a kickstand 32 on kickstand stops 43. Resistance tension cords 17 have ends with cord holders 7 that can be secured onto the front cap 8 in cord notches 9. FIG. 5 shows a carriage lock 44 that locks the carriage in respect to the rails for setup with a user.

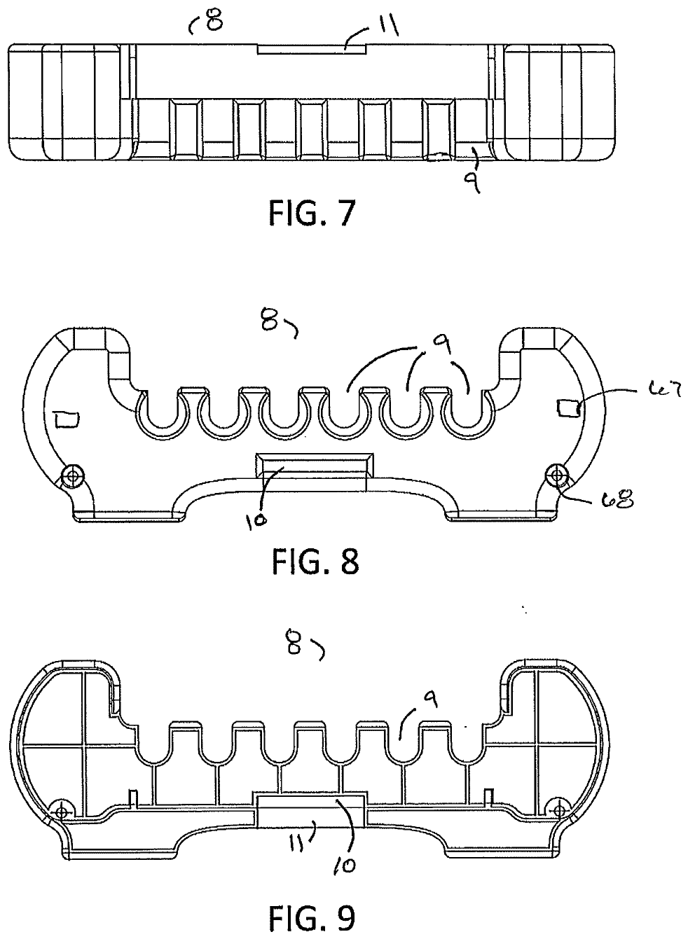

FIG. 6 shows the front cap 8 and the cord notches 9 are utilized to hold the cord holder during resistance exercise while the cord is allowed to pass thru the notch 9. The front cap's lumbar strap hole 10 allows the lumbar strap 5 to pass thru the front cap 8 and adjust the length easily. As shown in FIG. 7-9, a front cap strap fillet 11 located on the back side of the front cap allows the lumbar strap 5 to easily slide thru for length adjustability. Side clip holes 67 are located on the front cap 8 as well a screw holes 68 to secure the front cap onto the rails 12.

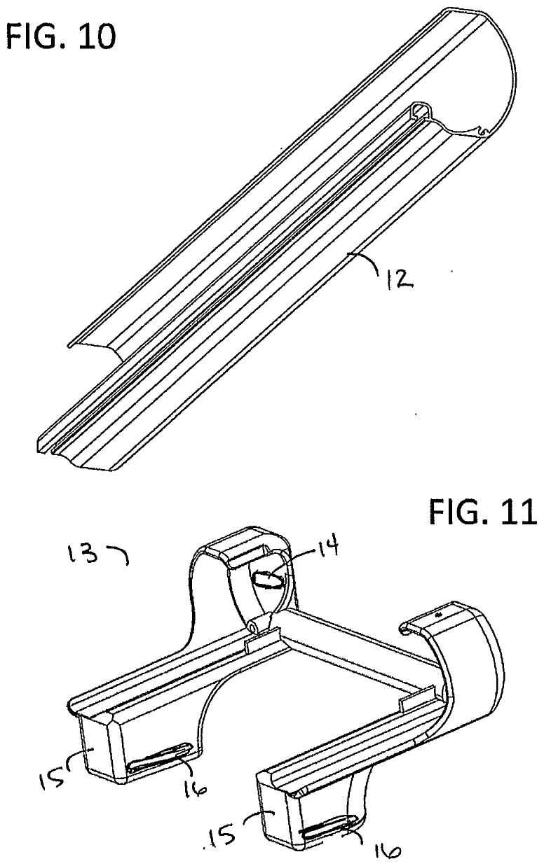

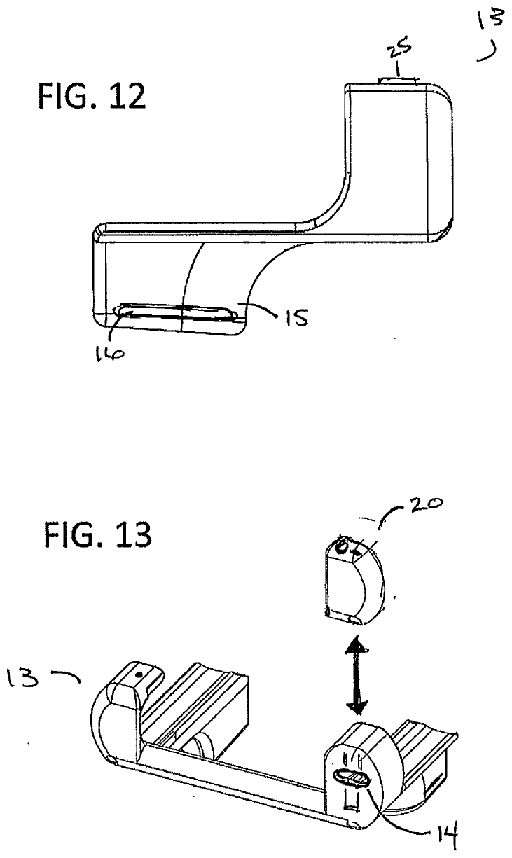

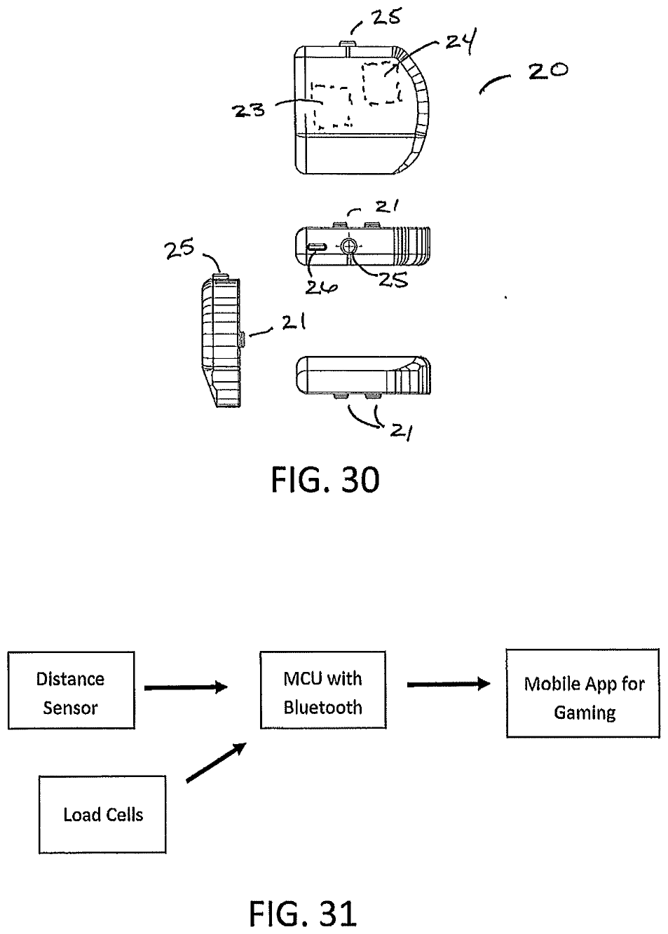

FIG. 10 shows the extruded aluminum rail 12 while FIGS. 11-13 displays the back cap 13 that attaches to the rails 12 on the back end. Back cap forward feet 15 are designed to keep the feet from falling off a bed surface while a back cap strap hole 16 located on the back feet 15 allows a strap to pass thru for extra stability during exercise. A back cap sensor cutout 14 is located in the back of a rail 12 which allows a distance sensor to detect the distance to the carriage and rate of carriage travel. As best shown in FIG. 13, a detachable game device 20 can be attached to the back cap 13 for visual biofeedback on a mobile phone or tablet to play games. FIGS. 30 and 31 will discuss in more detail of the game device 20.

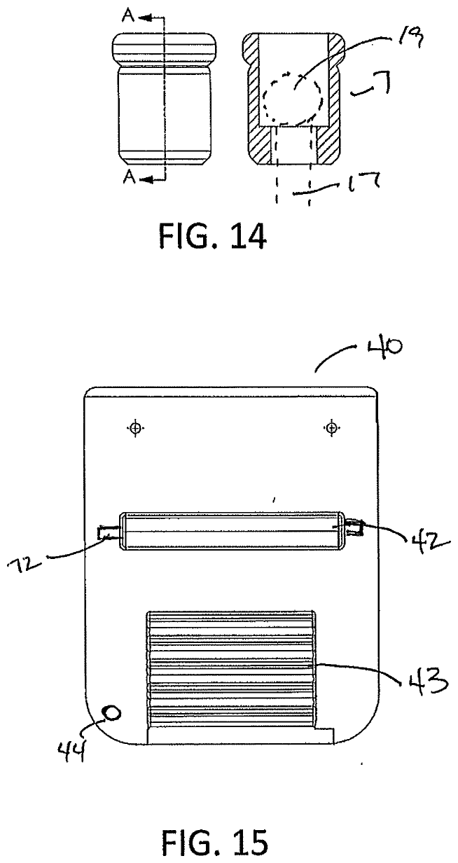

FIG. 14 displays the cord holder 7 which is at both ends of the tension cord 17. The cord holder 19 has an opening for the tension cord 17 but does not allow passage of the larger tension cord end 19. The cord holder makes it easy to change resistance levels by placing the cord holder into the cord notches of the front cap 9.

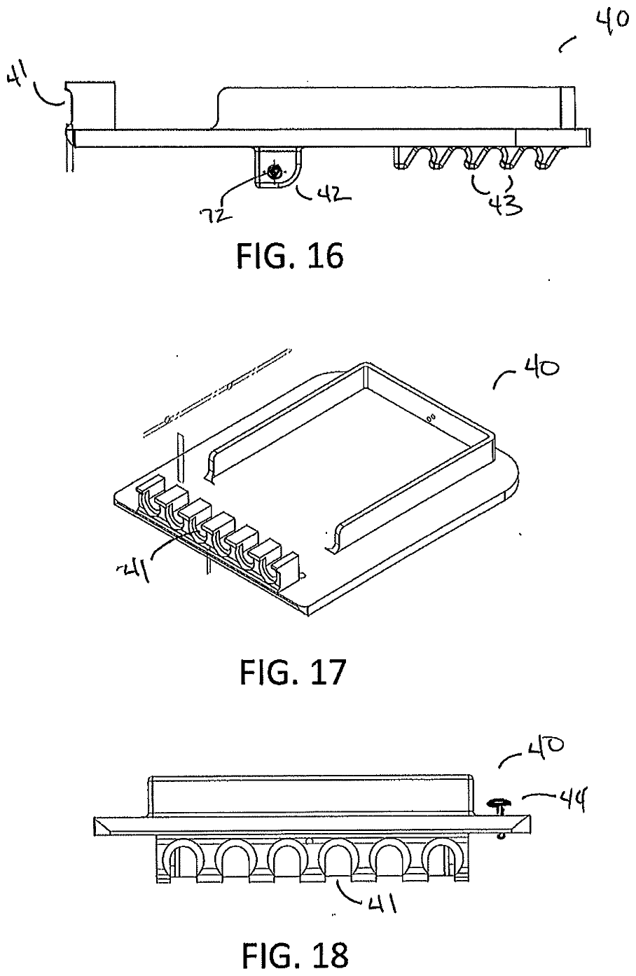

FIGS. 15-18 displays views of the carriage top 40. Axle housing 42 allows the footplate 30 to swivel on the footplate axle 72 and adjust to various inclines by being placed in varying kickstand stops 43. A carriage lock 44 is located on the carriage top 40 which fixates the carriage in place during setup. Carriage cord holders 41 are located at the front of the carriage top 40 that allows the tension cord holders 7 and tension cords 17 to be stowed away while not being used for exercise. Carriage top 40 is secured to carriage bottom 50 using screws 56 and heat-inserted nuts 57.

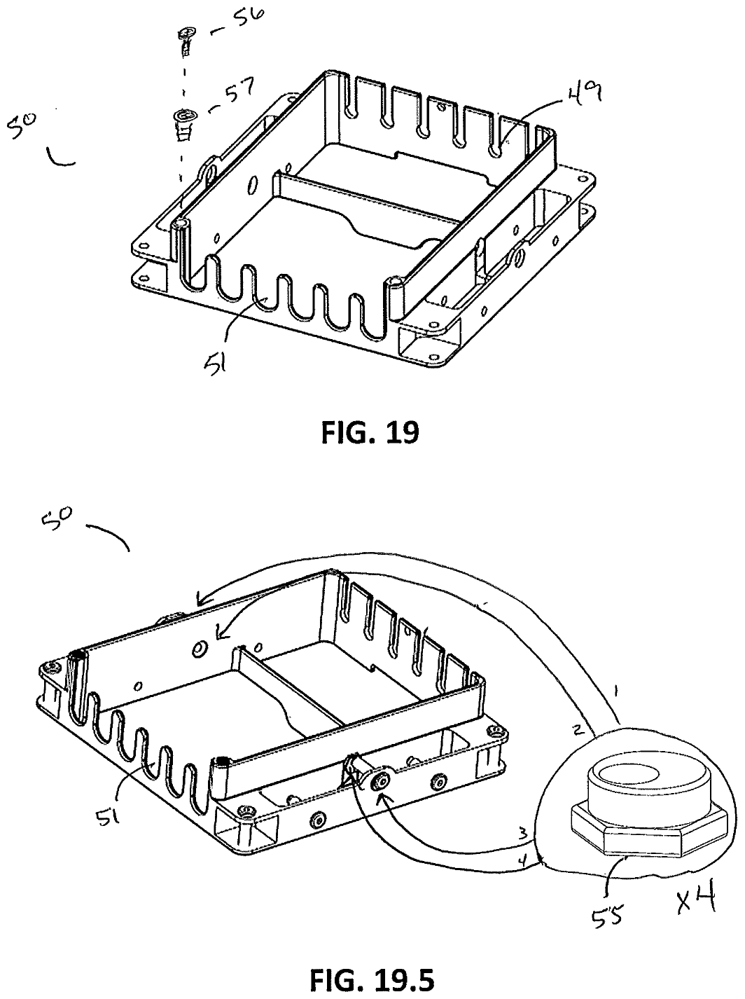

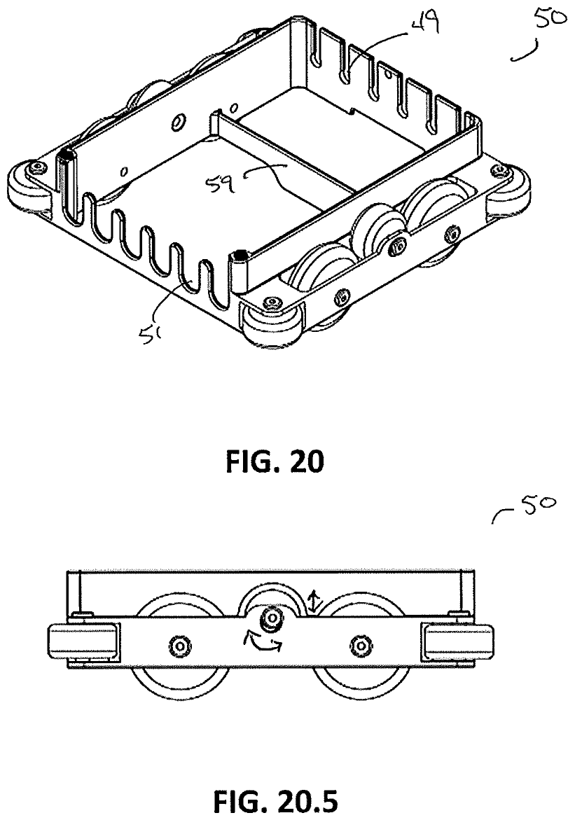

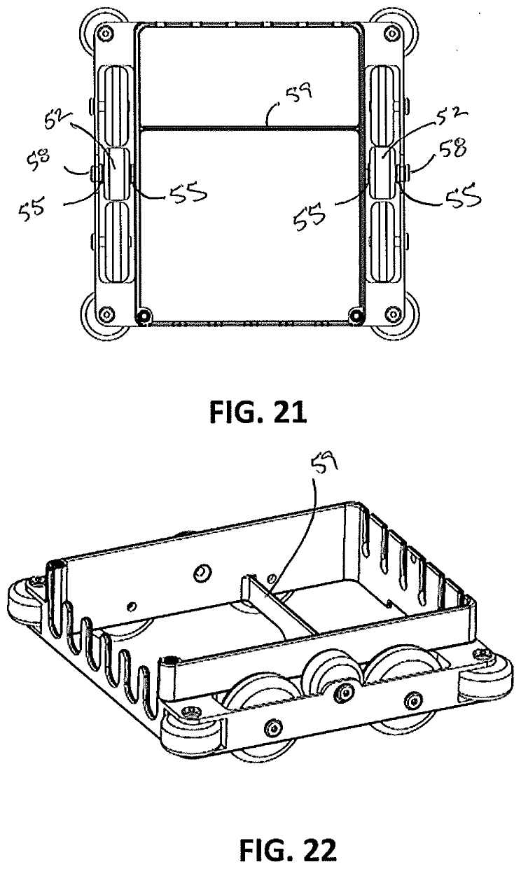

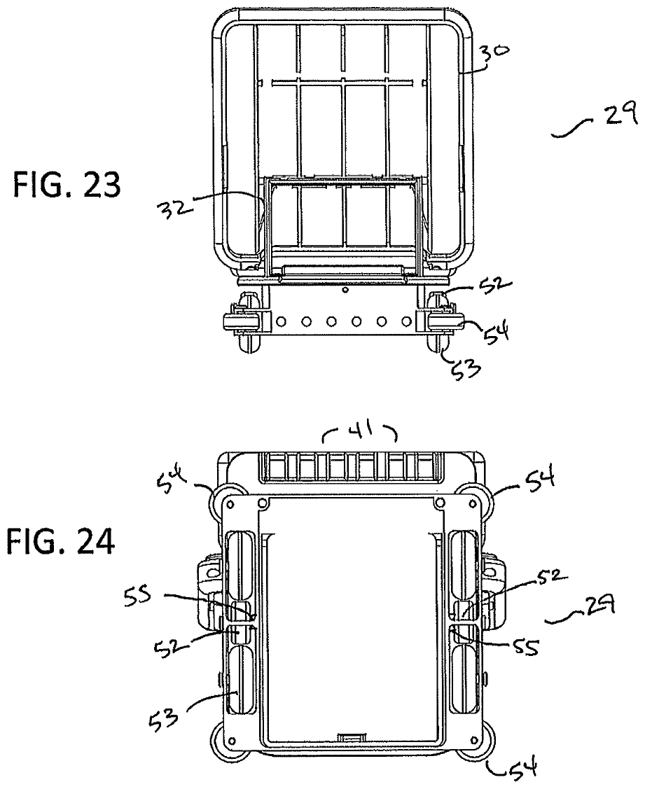

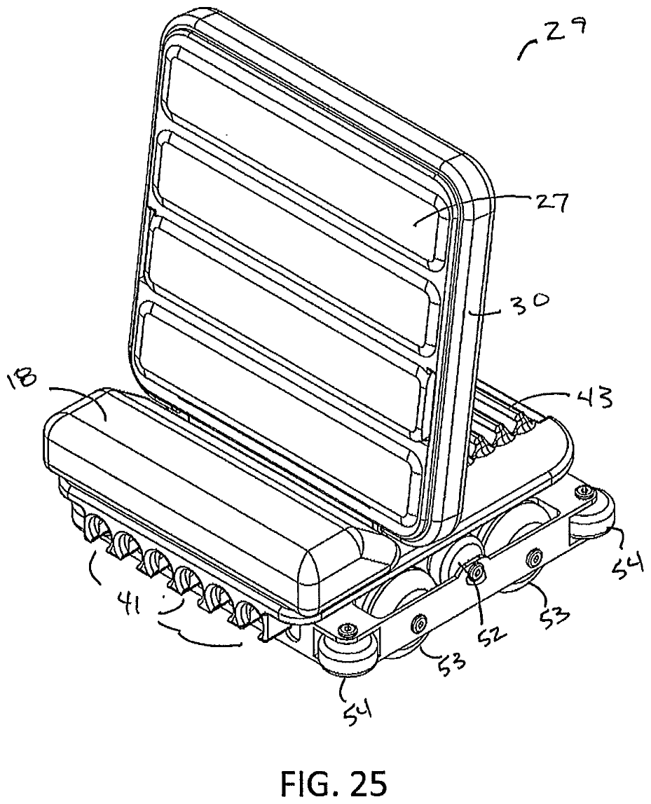

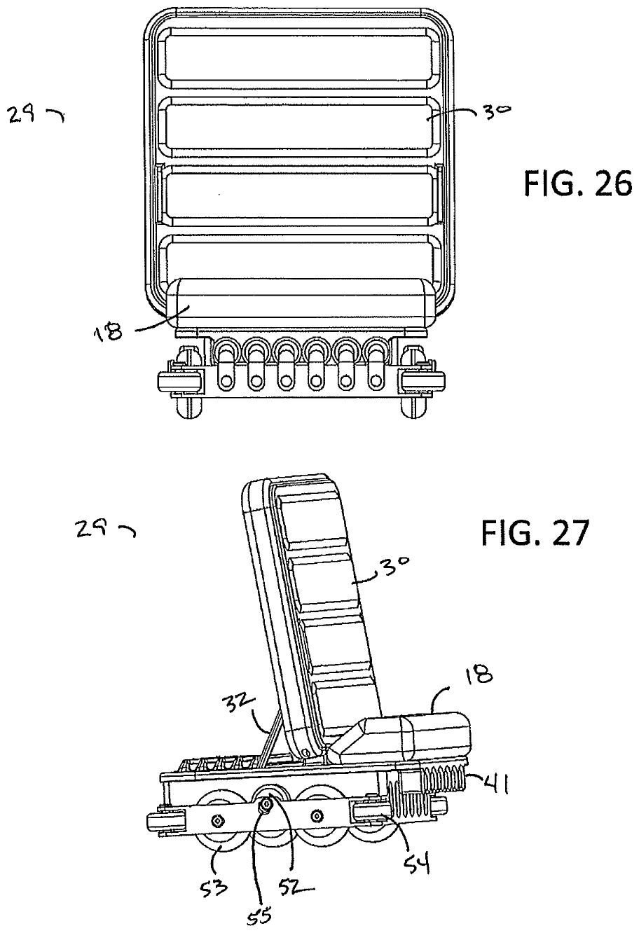

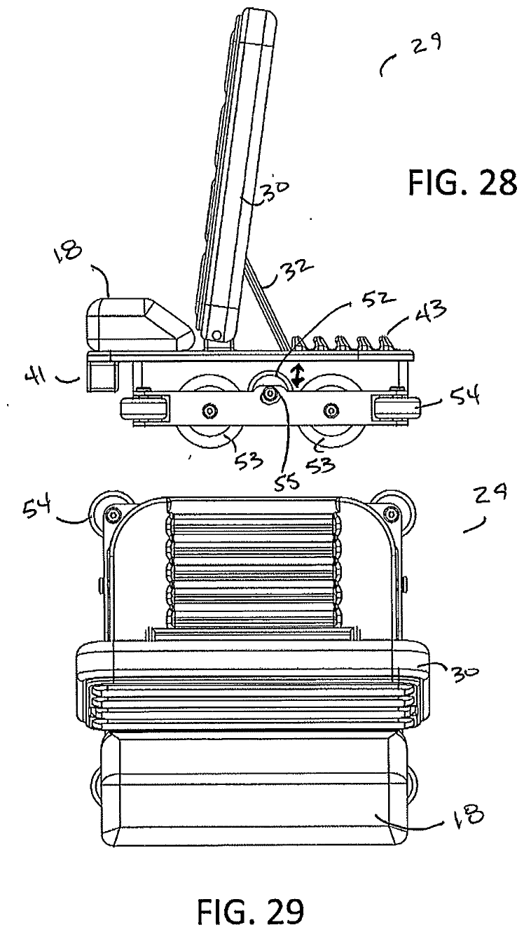

Carriage bottom 50 is displayed in FIGS. 19-22. The front of carriage bottom (Facing the user) has cord cutouts 51 that allow the tension cords to travel up and down for placement onto the front cap or stowed on the carriage. These cutouts 51 can be enclosed or open at the top to allow easy changing of tension cords if one was to break. Carriage bottom cord anchor holes 49 are located on the back of the carriage bottom 50 (Facing away from the user). These holes 49 can also be enclosed or open at the top to switch out tension cords easily. Also located on both sides of the carriage bottom 50 are holes for ten wheel axles for linear movement on the rails. As best shown in FIG. 19.5-29, the carriage assembly 29 is comprised of the footplate 30, ankle cushion 18, kickstand 32, carriage top 40, and carriage bottom 50. Side wheels 54 are located at the 4 corners of the carriage assembly in a horizontal fashion. These wheels control side-to-side movement during the exercise. Bottom rail wheels 53 are larger wheels that allow linear movement and ride on the bottom side of the rail 12. The top rail wheels 52 ride the top of the rail 12 for linear movement. Eccentric spacer nuts 55 are located on both sides of the top wheel axle 58 of top rail wheels 52 (4 eccentric spacers in total). The eccentric spacer 55 allows fine adjustments up and down of the top rail wheels 52 to accommodate for any variance in height of the rails 12 during assembly of the device. Turning the eccentric spacer 55 will change the top wheel axle 58 height as shown in FIG. 19.5 and FIG. 21. A center laser stopping beam 59 is located on the bottom carriage which stops the distance sensor's 20 beam and allows continuous data for carriage travel.

FIGS. 30 and 31 displays the game device 20 which slides into place on the back cap 13. A distance sensor 21 faces into the rail 12 and bounces off the carriage assembly 29 to show the carriage distance and rate of travel. The data from the distance sensor 21 is sent to the microcontroller unit 23 which is powered by a battery 24. An on/off button 25 is located on top of the game device 20 as well as a charging port 26. The microcontroller unit 23 has Bluetooth capability to relay the carriage distance to a mobile phone or tablet App to play games during exercise for entertainment.

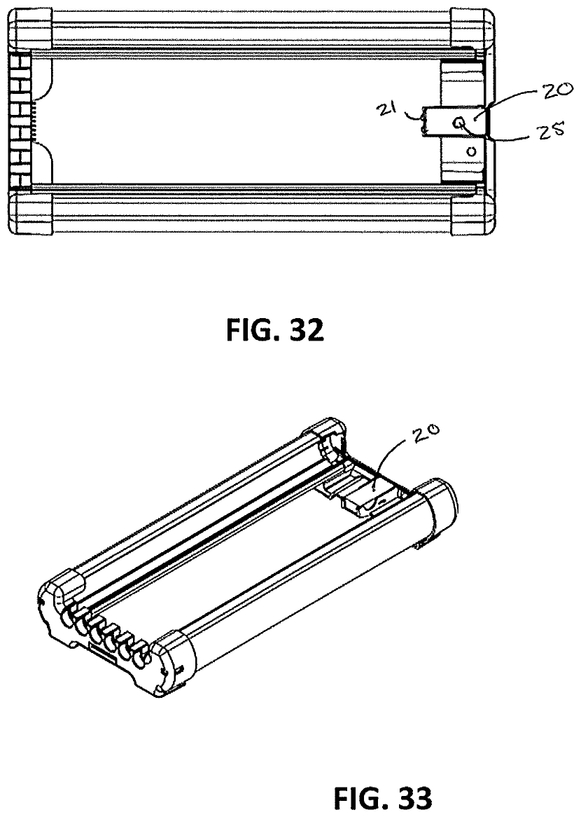

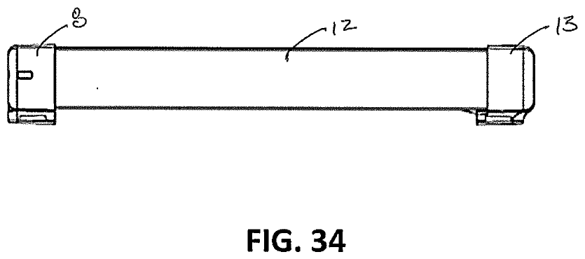

FIGS. 32-34 show an alternate device base with a centered detachable game device 20. Game device 20 has an on/off button 25 and distance sensor 21 that emits a laser beam to the carriage beam 59, allowing travel distance to be constantly assessed and bluetooth to the gaming app of the phone or tablet 2.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A portable rehabilitation device comprising:
a support base having a front end, a rear end, and a longitudinal axis, the support base having two longitudinally extending rails;
a moving carriage mounted on the support base and engaging the rails for back and forth travel along the longitudinal axis;
at least one tension cord adjustably attached between the moving carriage and the front end of the support base;
a footplate mounted on the moving carriage; and
a lumbar bolster adjustably attached to the support base.

2. The device of claim 1, wherein the moving carriage includes a plurality of vertical wheels controlling vertical motion of the moving carriage and a plurality of horizontal wheels controlling lateral motion of the moving carriage.

3. The device of claim 2, wherein the vertical wheels include at least two top rail wheels wherein each top rail wheel includes an eccentric spacer nut for adjusting wheel axle placement.

4. The device of claim 1, further comprising a distance sensor mounted on the support base and configured to detect position of the moving carriage, and a microcontroller unit connected to the distance sensor wherein the microcontroller unit is configured to transmit carriage position data to a mobile device.

5. The device of claim 1, wherein the at least one tension cord includes a cord holder configured to engage with a cord notch on a front cap attached to the front end of the support base.

6. The device of claim 1, further comprising an ankle support cushion connected to the footplate.

7. The device of claim 1, wherein the footplate is adjustable at various angular positions via a kickstand.

8. A rehabilitation exercise system comprising:
a support base with longitudinal rails;
a moving carriage mounted on the rails;
an adjustable footplate mounted on the moving carriage;
a distance sensor mounted on the support base;
a microcontroller unit connected to the distance sensor; and
a mobile device configured to receive position data from the microcontroller unit and display interactive exercise feedback.

9. The system of claim 8, further comprising a lumbar bolster adjustably attached to the support base.

10. The system of claim 8, wherein the moving carriage further comprises:
an ankle support cushion mounted on the adjustable footplate; and
a plurality of bearing wheels engaging the rails.

11. The system of claim 8, wherein the mobile device is configured to display interactive exercise feedback within a mobile application game environment.

12. The system of claim 10, wherein the footplate further comprises a load cell configured to measure force applied by a user during exercise.

13. A method of providing rehabilitation exercise, comprising:
positioning a support base with longitudinal rails adjacent to a patient's extended leg;
placing a lumbar bolster under the patient's back;
adjusting a strap connected between the lumbar bolster and the support base;
positioning a moving carriage mounted on the rails for engagement with the patient's foot; and
allowing the moving carriage to move along the rails against resistance during exercise.

14. The method of claim 14, further comprising detecting position of the moving carriage using a distance sensor, and transmitting position data to a mobile device.

15. The method of claim 14, further comprising attaching at least one tension cord between the moving carriage and the support base to provide resistance.

16. The method of claim 14, further comprising adjusting an angle of a footplate mounted on the moving carriage.

17. The method of claim 16, further comprising supporting the patient's ankle with a cushion mounted on the footplate.

18. The method of claim 16, further comprising securing the patient's foot to the footplate with a foot strap.

19. The method of claim 14, further comprising displaying interactive exercise feedback on a mobile device based on movement of the moving carriage.

20. The method of claim 19, wherein the step of displaying interactive exercise feedback on a mobile device is done within a mobile application game environment.
